(19) United States
(12) Patent Application Publication
(10) Pub. No.: US 2004/0139409 A1
(43) Pub. Date: Jul. 15, 2004

(54) Automatic circuit design apparatus and computer-implemented automatic circuit design method

(75) Inventors: Hideaki Nagasawa, Tokyo (JP); Yasushi Okamoto, Tokyo (JP); Masatsugu Murai, Hyogo (JP); Naoki Hasegawa, Hyogo (JP)

Correspondence Address: LEYDIG VOIT & MAYER, LTD, 700 THIRTEENTH ST. NW, SUITE 300, WASHINGTON, DC, 20005-3960, US

(73) Assignees: Renesas Technology Corp., Tokyo (JP); Renesas Device Design Corp., Itami-shi (JP)

(21) Appl. No.: 10/743,765

(22) Filed: Dec. 24, 2003

(30) Foreign Application Priority Data
Dec. 27, 2002 (JP) 2002-381786

(51) Int. Cl. G06F 17/50

(52) U.S. Cl. 716/5; 716/12; 716/4

(57) ABSTRACT

An automatic circuit design apparatus includes an analyzer (11) for analyzing a file in a form of a table, in which both connection conditions concerning a plurality of circuit components (e.g., intellectual properties) within an integrated circuit and connections among the plurality of circuit components corresponding to the connection conditions are described, and a description creating unit (12) for creating a description of the integrated circuit according to HDL based on analytical results from the analyzer (11).

### BACKGROUND OF THE INVENTION

1. Field of the Invention

The present invention relates to an automatic circuit design apparatus and a computer-implemented automatic circuit design method.

2. Description of Related Art

Recent years have seen that large-scale integrated circuits (LSI) have complicated specifications and increase in size. Therefore, a design method using a hardware description language (HDL) that is a high-level language has been widely used to design large-scale integrated circuits, instead of a design method using a gate-level netlist.

As the technology of large-scale integrated circuits (LSI) progresses, functional blocks that constitute a system LSI are, as IPs (intellectual properties) that are shared properties used to design LSIs, put into circulation and recycled. It is possible to design the whole of an LSI (i.e., a top-level circuit) or a module by combining a plurality of existing IPs with other existing circuit components, and this results in facilitating the design task. In general, most of IPs widely put into circulation are described in a register-transfer-level (RTL) of HDL.

However, even in accordance with such a design method, in order to connect IPs or other circuit components with one another, designers are required to have some complicated thinking, such as arrangement of circuit components that should be added to the integrated circuit, such as selector modules and a control signal creating module that controls the selector modules, while envisaging the difference among signals to be supplied to circuit components according to each of conditions (i.e., modes) under which the integrated circuit operates. Designers create a description (i.e., a source) of the integrated circuit in view of the circumstances. In general, in order to create a description of an actual integrated circuit by using IPs or other circuit components based on necessary design specifications, designers need knowledge about HDL, especially the register-transfer-level of HDL. Therefore, only limited persons can design LSIs.

Recently, the number of ports in one IP increases, and it is not unusual for IPs to need a number of connections that exceeds several hundreds. Therefore, because designers occasionally and manually rewrites the circuit description written in HDL at much expense in manpower and time, the frequency of occurrence of connection failures due to description errors increases.

### SUMMARY OF THE INVENTION

The present invention is proposed to solve the above-mentioned problems, and it is therefore an object of the present invention to provide an automatic circuit design apparatus and a computer-implemented automatic circuit design method that facilitates an automatic design of an integrated circuit in which a plurality of circuit component are connected to one another, thereby reducing the manpower and time required for creating a circuit description written in HDL.

In accordance with the present invention, there is provided an automatic circuit design apparatus including an analyzer for analyzing a data set in a form of a table, in which both connection conditions concerning a plurality of circuit components within an integrated circuit and connections among the circuit components corresponding to each of the connection conditions are described, and a description creating unit for creating a description of the integrated circuit with a hardware description language based on analytical results from the analyzer.

As a result, the automatic circuit design apparatus can facilitate an automatic design of an integrated circuit in which a plurality of circuit component are connected to one another, thereby reducing the manpower and time required for creating a circuit description written in HDL.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing an automatic circuit design apparatus according to embodiment 1 of the present invention;

FIG. 2 is a flow chart showing an operation of the automatic circuit design apparatus according to embodiment 1 of the present invention;

FIG. 3 is an example of a table filled by a designer, which can be used by the automatic circuit design apparatus according to embodiment 1;

FIG. 4 is circuit diagram showing a target circuit that is to be finally designed based on the table of FIG. 3;

FIG. 5 is a list showing a part of a circuit description created based on the table of FIG. 3;

FIG. 6 is a diagram for explaining a basic idea behind a process of creating a description of a target LSI to be designed in accordance with embodiment 1;

FIG. 7 is a list showing a simplified condition definition sentence that defines connection conditions listed in the table of FIG. 3;

FIG. 8 is an example of a table that can be used by the automatic circuit design apparatus according to embodiment 1;

FIG. 9 is circuit diagram showing a target circuit that is to be finally designed based on the table of FIG. 8;

FIG. 10 is a list showing a simplified description of each selector module included in the circuit shown in FIG. 9;

FIG. 11 is a list showing a simplified description of an encoder module included in the circuit shown in FIG. 9;

FIG. 12 is a circuit diagram showing a branch module that is inserted into the target LSI by the automatic circuit design apparatus according to embodiment 1;

FIG. 13 is a circuit diagram showing a gate module that is added to the target LSI by the automatic circuit design apparatus according to embodiment 1 when inserting a special module into the target LSI;

FIG. 14 is a diagram showing an example of a plurality of tables that can be used by the automatic circuit design apparatus according to embodiment 1;

FIG. 15 is a circuit diagram showing a top-level circuit that can be automatically designed based on the plurality of tables of FIG. 14;

FIG. 16 is a table showing an example of a created top-level table in which connection conditions concerning a plurality of circuit components (i.e., pins and IPs) included in the entire LSI and connections among the plurality of circuit components corresponding to each of those connection conditions;

FIG. 17 is a circuit diagram showing an example of the top-level circuit designed by the automatic circuit design apparatus according to embodiment 1;

FIG. 18 is a table showing an example of a created lower-level table in which connection conditions concerning a plurality of internal elements included in an IP A and connections among the plurality of internal elements corresponding to each of those connection conditions;

FIG. 19 is a table showing an example of a created lower-level table in which connection conditions concerning a plurality of internal elements included in another IP B and connections among the plurality of internal elements corresponding to each of those connection conditions; and

FIG. 20 is a table showing an example of a created lower-level table in which connection conditions concerning a plurality of internal elements included in another IP C and connections among the plurality of internal elements corresponding to each of those connection conditions.

### DETAILED DESCRIPTION OF THE PREFERRED EMBODIMENTS

The invention will now be described with reference to the accompanying drawings.

Embodiment 1.

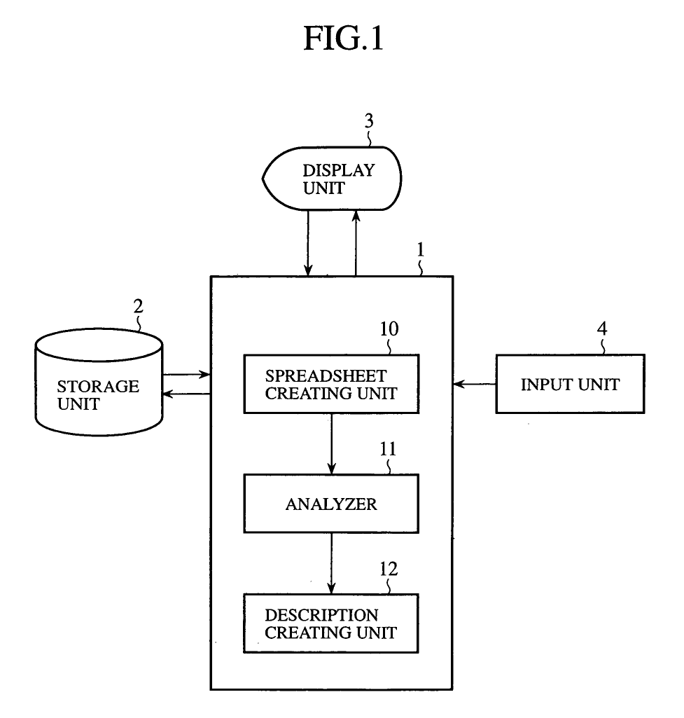

FIG. 1 is a block diagram showing an automatic circuit design apparatus according to embodiment 1 of the present invention. This automatic circuit design apparatus has a processor 1 that is a computer which operates according to a software program, a storage unit 2, a display unit 3, and an input circuit 4.

The storage unit 2 is a hard disk, for example, and stores files (i.e., data sets) to be used by the processor 1 and files created by the processor 1. The processor 1 can store files in a storage medium other than the storage unit 2 and can send files to other apparatuses by using a communication device, not shown in the figure. The processor 1 can further control the display unit 3 based on these files so as to make the display unit 3 display images and then provide information to a designer. The designer can provide an instruction to the processor 1 by using the input circuit 4.

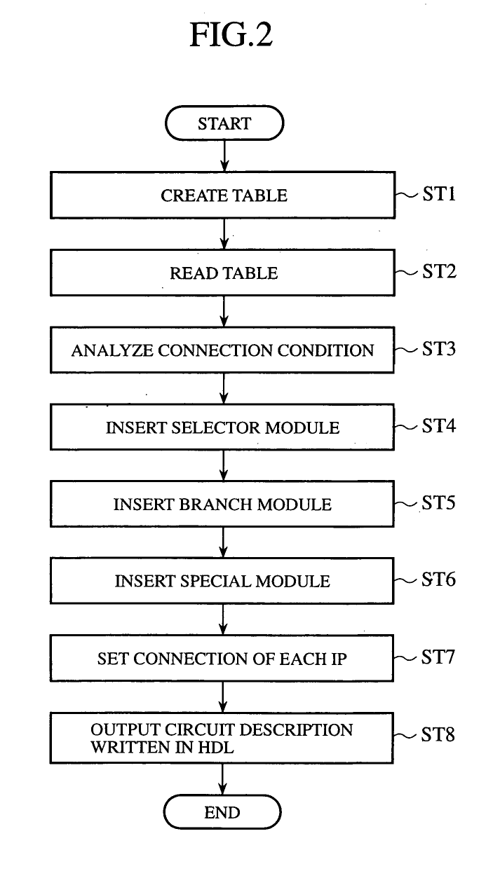

The processor 1 can be divided by function, i.e., executable program module into a spreadsheet program creating unit 10, an analyzer 11, and a description creating unit 1, for the sake of convenience. Next, operations which the processor 1 performs according to a software program will be explained with reference to a flow chart of FIG. 2.

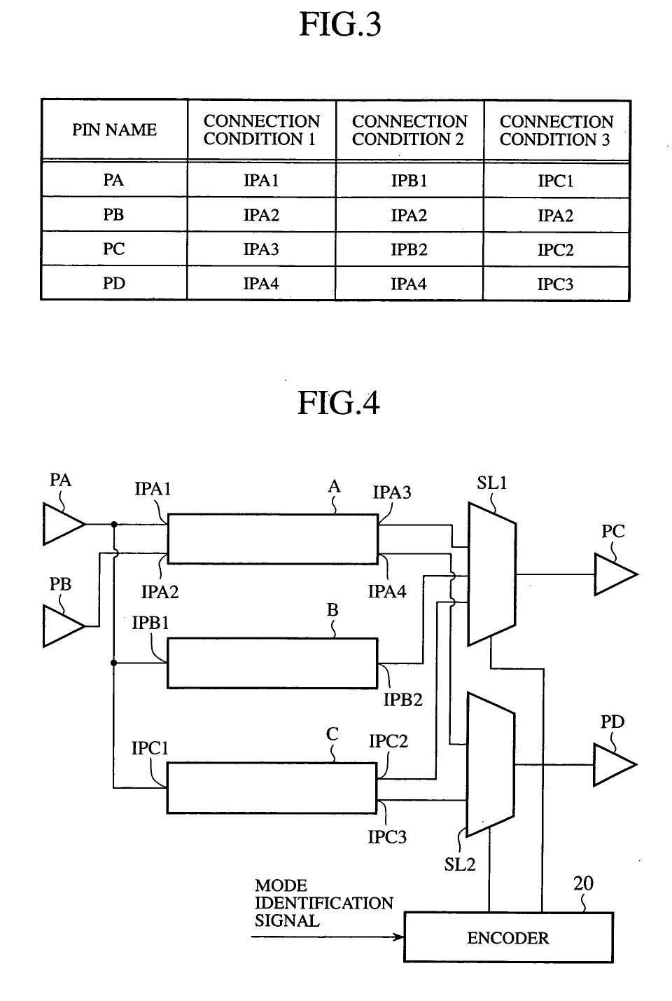

First of all, the spreadsheet program creating unit 10, in step ST1, displays a screen in the form of a table (i.e., a spreadsheet program form) on the display unit 3 so as to urge the designer to write information into a table, i.e., create a table. An example of the table displayed on the display unit and filled by the designer is shown in FIG. 3. Each row of this table shows connection information about connections of each pin (i.e., a pad or I/O cell) of a module that can be an LSI or a part of an LSI. The names of those pins are written in the first column, and elements respectively connected to those pins are listed in each of other columns. This table is separated into the plurality of columns according to conditions (i.e., connection conditions 1 to 3) under each of which a connection is established, and indicates with which element each pin is connected under each connection condition. For example, those connection conditions can include operation modes of the LSI.

The example of FIG. 3 shows with which pin of IPA1 to IPA4, IPB1, IPB2, and IPC1 to IPC3 of IPs (or circuit components) A, B, and C each pin PA, PB, PC, or PD is connected under each of connection conditions 1 to 3. Concretely, the table of FIG. 3 shows that the pin PA is connected to the first pin IPA1 of the IP A under connection condition 1, is connected to the first pin IPB1 of the IP B under connection condition 2, and is connected to the first pin IPC1 of the IP C under connection condition 3. The table of FIG. 3 further shows that the pin PB is connected to the second pin IPA2 of the IP A under any connection condition. In other words, this table describes connection conditions (e.g., connection conditions 1 to 3) concerning a plurality of circuit component included in the target LSI and connections among circuit components corresponding to these connection conditions.

The spreadsheet program creating unit 10 displays a format of the table (i.e., a table having empty columns) on the display unit 3. The designer can write information into each column in the table graphically displayed on the display unit 3 by using the input circuit 4 (e.g., a pointing device, such as a mouse, and a keyboard) while taking necessary design specifications into consideration. When thus creating the table, the designer can store a spreadsheet program file corresponding to the table in the storage unit 2 by operating the input circuit 4.

In order to facilitate the understanding of creating a table, the target circuit finally designed based on the table of FIG. 3 is shown in FIG. 4. As can be seen from FIG. 4, the pins PA and PB are elements via which signals are input to the IPs A, B, and C, and the pins PC and PD are elements that accept signals delivered from the IPs A, B, and C. In the target circuit, selector modules SL1 and SL2, and an encoder module 20 (i.e., a control signal creating module) are disposed in order to change the connections among the IPs A, B and C and the pins PA and PB according to each of the connection conditions 1 to 3. These selector modules SL1 and SL2 and the encoder module 20 are inserted into the target circuit by the processor 1 that works according to the software program, as described below.

As shown in FIG. 2, the analyzer 11, in step ST2, reads the table and analyzes internal data in the table after the spreadsheet program creating unit 10 creating the table. The analyzer 11 can read the spreadsheet file from the storage unit 2. As an alternative, the analyzer can read the table that is not stored in the storage unit 2.

After that, the description creating unit 12 creates descriptions of necessary modules and signals with HDL based on analytical results from the analyzer 11 (in steps ST3 to ST7), and delivers a circuit description that is a combination of the acquired descriptions of modules and signals (in step ST8). As a result, the designer can check the acquired circuit description displayed on the display unit 3, and can store the circuit description file written in HDL in the storage unit 2 by operating the input circuit 4.

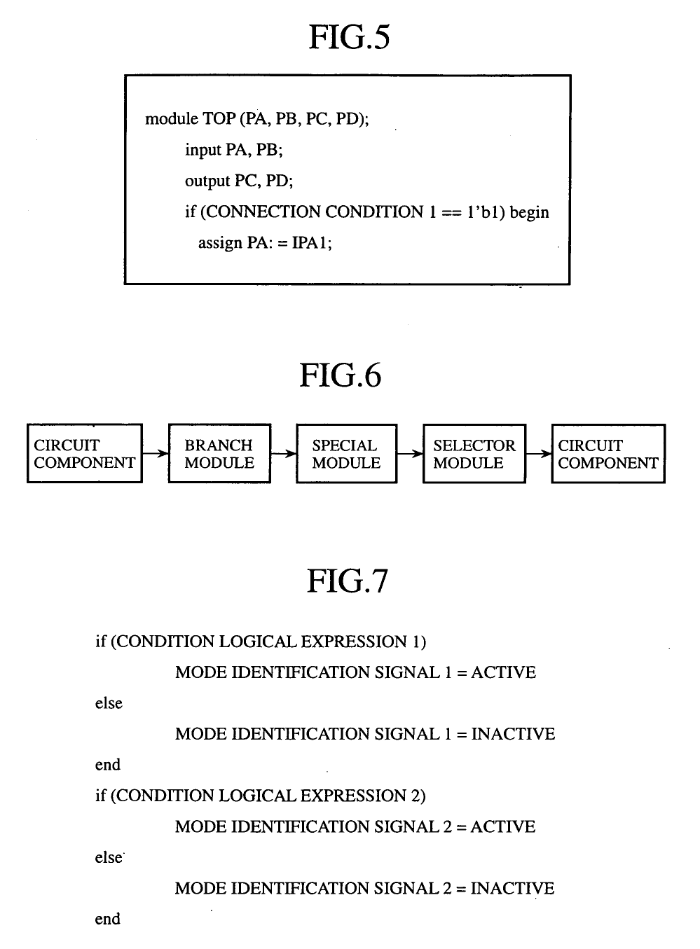

FIG. 5 is a list showing an excerpted part of the circuit description that is created based on the table of FIG. 3. The circuit description, as shown in FIG. 5 and other figures of this embodiment, complies with RTL (i.e., resistor-transfer-level) of “Verilog-HDL”. The first row indicates that the designed circuit is the whole of an LSI (i.e., a top-level circuit or top-level module) including a plurality of IPs and having pins PA, PB, PC, and PD. The second and third rows indicate that the pins PA and PB are elements via which signals are input, and the pins PC and PD are elements that accept output signals. The fourth and fifth rows indicate that the pin PA is connected to the first pin IPA1 of the IP A when the connection condition 1 is satisfied (i.e., when the connection condition 1 agrees with a condition 1'b1). In this case, the designer has specified that the condition 1 'b1 corresponds to the connection condition 1.

As shown in FIG. 2, the process of creating definition sentences of necessary modules with HDL based on the analysis of the table includes a step of analyzing connection conditions (step ST3), a step of inserting selector modules (step ST4), a step of inserting branch modules (step ST5), a step of inserting special modules (step ST6), and a step of defining connections of each IP (step ST7). The steps ST4 to ST7 need not be necessarily carried out in the order that they are shown in the flow chart of FIG. 2. As an alternative, those steps can be carried out in another order, or can be carried out in parallel with one another, or the software program can be so created that either one of those steps ST4 to ST7 can be arbitrarily omitted.

Next, a basic idea behind the process of creating a description of the target LSI will be explained. Referring to FIG. 6, there is illustrated an example in which wiring for connecting a plurality of circuit component specified by the designer is provided. As shown in the figure, wiring for connecting among the plurality of circuit components can be assumed to be defined as one or more modules. The description creating unit 12 selects an appropriate module according to connection conditions and connections described in the table. These modules are held, as specific objects that the program uses, by the processor 1 until a final circuit description is furnished in step ST8. In steps ST3 to ST7 of the program, an appropriate cell (e.g., a minimum circuit element) is arranged in each block as illustrated in FIG. 6. The arrangement of such a cell corresponds to a change in a method of a corresponding object.

Hereafter, each step of the program will be explained in more detail. In performing step ST2 (FIG. 2) of reading the table, the analyzer 11 extracts the connection information listed at each row of the table. The extracted connection information is stored, as a specific object that the program uses, by the analyzer 11. In this case, two-level objects are used. A first-level object is a pin object holding the pin name of a corresponding pin and data on the destination to which the corresponding pin is connected under each connection condition, and a second-level object holds a plurality of pin objects and is a module object (or an IP object) representing the entire table. In each following step, the description creating unit 12 adds a description of each module or signal, as a method used by a corresponding object, to the description of the target circuit, or changes the description of each module or signal.

In performing step ST3 (FIG. 2) of analyzing connection conditions, the description creating unit 12 analyzes a connection condition listed at each column of the table. Concretely, the description creating unit 12 provides a signal (referred to as a mode identification signal) that is activated under each connection condition, and creates a condition definition sentence that associates each connection condition with a mode identification number. In the case of the table having three types of connection conditions (i.e., three modes) as shown in FIG. 3, three mode identification signals are defined, either one of the three mode identification signals is activated according to each connection condition and other mode identification signals are inactivated.

Each of the connection conditions 1 to 3 shown in FIGS. 3 and 5 is actually represented by a condition logical expression indicating whether a certain signal line is placed at a low level (L) or a high level (H), or by a condition logical expression indicating whether or not each of some signal lines is placed at a low level or a high level. The analyzer 11 holds condition logical expressions written into the table of FIG. 3 in such a format, and the description creating unit 12 creates a condition definition sentence that associates these condition logical expressions with the three mode identification signals through analysis of the connection conditions 1 to 3. At this time, it is preferable to prevent the plurality of mode identification signals from being activated at the same time. Therefore, condition branch expressions used by the condition definition sentence should be mutually exclusive. Finally, the description creating unit 12 creates a description that means the condition definition sentence including condition branch expressions as shown in FIG. 7.

In performing step ST4 (FIG. 2) of inserting selector modules, the description creating unit 12 selects appropriate selector modules (e.g., selector modules SL1 and SL2) suitable for implementing connections of each circuit component according to each connection condition, and holds a definition sentence concerning the selector modules. The description creating unit 12 further adds information about an appropriate control signal creating module suitable for creating a control signal used to control each of the selector modules to the description of the target LSI.

Concretely, according to the software program the description creating unit 12 searches for a destination to which each pin is connected for each circuit component (e.g., each IP), and counts the number of destinations to which each pin is connected. For example, in the table of FIG. 3, the destinations to which the pin PC as an input pin of other circuit components (not shown) is connected for the IPs A, B, and C are pins IPA3, IPB2, and IPC2 and the number of them is three while the destinations to which the pin PD is connected for the IPs A, B, and C and other circuit components are pins IPA4 and IPC3 and the number of them is two (identical destinations are counted only one time). The description creating unit 12 holds the thus-examined destinations as an array which the program uses. The array representing these connection destinations is referred to as the connection recognition array from here on.

The description creating unit 12 creates and holds a connection definition sentence in which connections of the appropriate selector modules with appropriate pins are described based on the connection recognition array and the number of connection destinations. Each selector module has a plurality of inputs whose number is the same as that of connection destinations and one output regardless of the number of connection conditions. For example, the selector module SL1 having three inputs and one output is selected for the pin PC.

In case where only one destination is connected to an input pin, the description creating unit 12 creates and holds either a simple connection definition sentence or a sentence in which only a buffer is described without inserting any selector module. For example, because only one pin PA is connected to the input pin IPA1 of the IP A, the description creating unit 12 creates and holds either a definition sentence that defines only a connection between the pin IPA1 and the pin PA or a sentence that defines provision of a buffer between the pin IPA1 and the pin PA.

In addition, the description creating unit 12 defines a control signal creating module (i.e., an encoder module). The control signal creating module furnishes a control signal for controlling the selector modules according to the mode distinction number to each selector module. The control signal creating module is defined based on the above-mentioned connection conditions and the connection recognition array. The description creating unit 12 creates and holds a connection definition sentence in which the control signal creating module is appropriately connected to the selector modules.

Each selector module can select a path suitable for a set connection condition (e.g., an operation mode of the LSI) by using this control signal creating module. Furthermore, even if the same connection exists for a plurality of connection conditions, it is possible to select a path suitable for a set connection condition by using only a minimum number of selector modules without creating any redundant selector module.

In an actual LSI, different requests regarding the performance are made between in a normal use mode in which the LSI is normally used and in a secondary mode in which the LSI is secondarily used (e.g., a test mode in which the LSI is under test). In the normal use mode that is of importance, a high processing speed is requested and the power consumption should be reduced to a minimum. On the other hand, in most cases the test mode aims only to check to see whether each circuit component functionally operates, and has a higher acceptable level concerning each of the processing speed, capacitance, and resistance than the normal use mode. Then, it is preferable to provide a method of inserting selector modules in the design of an LSI with a plurality of secondary modes, as follows.

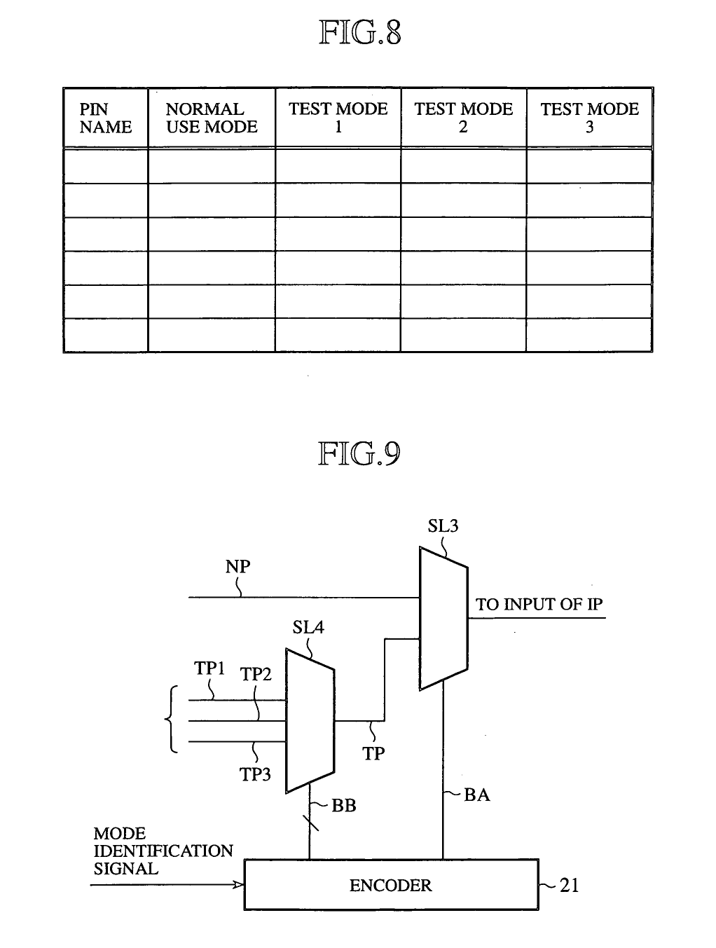

The designer completes a table as illustrated in FIG. 8 first in step ST1. This table describes a normal use mode in which the LSI is normally used and a plurality of secondary modes in each of which the LSI is secondarily used as connection conditions, respectively, and also describes connections among circuit components corresponding to each mode. In the connection condition analysis of step ST3, the description creating unit 12 creates a condition definition sentence that associates a mode at each column of the table with a mode identification number.

The description creating unit 12 then selects a first selector module placed among a plurality of circuit components (e.g., IPs) that are connected to one another in the normal use mode in performing step ST4 of inserting selector modules. The description creating unit 12 selects a second selector module suitable for implementing connections among circuit components in a plurality of test modes, and further creates a description concerning the first selector module and a description concerning the second selector module so that an output of the second selector module is connected to an input of the first selector module. The description creating unit 12 further creates a connection definition sentence in which a control signal creating module is connected to these selector modules.

FIG. 9 shows a target circuit that is finally designed based on the table as illustrated in FIG. 8. An input of a first selector module SL3 shown in the figure is connected to a normal path NP and a test path TP, and an output of the first selector module SL3 is connected to an input of a certain IP. Because a plurality of test modes are used, a plurality of test paths are needed. In this design example, the test path TP is branched to a plurality of test paths TP1 to TP3 by disposing a second selector module SL4 having an output connected to the test path TP.

An encoder module 21 (i.e., a control signal creating module) is disposed to control the two selector modules SL3 and SL4. The encoder module 21 is connected to the first selector module SL3 by way of a single signal line BA, and furnishes a control signal for selecting either of a signal on the normal path NP and a signal on the test path TP to the selector module SL3. The encoder module 21 is further connected to the second selector module SL4 by way of a plurality of parallel signal lines BB, and furnishes a control signal for selecting either of the test paths TP1 to TP3 to the selector module SL4 when making the selector module SL3 select the signal on the test path TP.

Thus the first selector module SL3 having two inputs and one output is disposed for the normal path NP and the test path TP, and the second selector module SL4 having three inputs and one output is disposed for the test paths TP1 to TP3. Therefore, even if one normal path NP and a plurality of test paths TP are provided for the target LSI that operates in either of one normal use mode and a plurality of test modes, because the first selector module SL3 has only two choices: the normal path NP and the test path group, the first selector module SL3 has the simplest internal structure (e.g., the number of internal gates and wiring pattern) among the plurality of selectors. Therefore, in the normal use mode, high-speed processing can be implemented and low power consumption can be achieved.

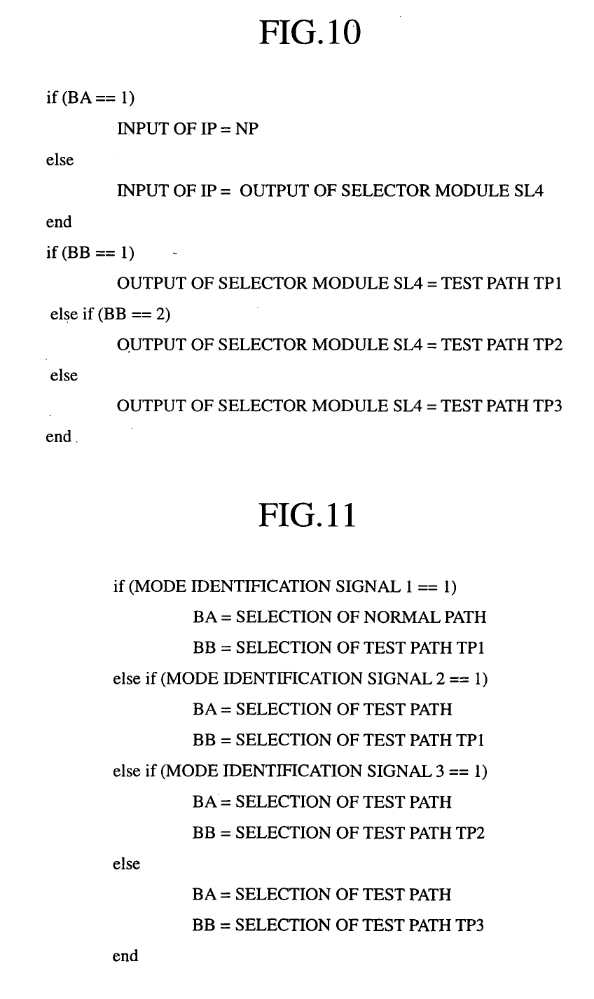

FIG. 10 is a list showing a simplified description of each selector module within the circuit shown in FIG. 9, and FIG. 11 is a list showing a simplified description of the encoder module within the circuit shown in FIG. 9.

The first through fifth rows of FIG. 10 show that when a signal on the signal line BA is at state 1, the selector module SL3 furnishes a signal on the normal path NP to the input of the IP, while otherwise the selector module SL3 furnishes an output signal of the other selector module SL4 to the input of the IP. The sixth and seventh rows show that when a signal on the signal line BB has a value of 1, the selector module SL4 furnishes a signal on the test path TP1 to the input of the IP. The eighth and ninth rows show that when the signal on the signal line BB has a value of 2, the selector module SL4 furnishes a signal on the test path TP2 to the input of the IP. The tenth and eleventh rows show that otherwise, the selector module SL4 furnishes a signal on the test path TP3 to the input of the IP.

The first through third rows of FIG. 11 show that when the mode identification signal 1 is at the on state, the encoder module 21 sends out a control signal for making the selector module SL3 select the normal path NP onto the signal line BA, and also sends out a control signal for making the selector module SL4 select the test path TP1, which is originally unwanted, onto the signal line BB. The fourth through sixth rows show that when the mode identification signal 2 is at the on state, the encoder module 21 sends out a control signal for making the selector module SL3 select the test path TP onto the signal line BA, and also sends out a control signal for making the selector module SL4 select the test path TP1 onto the signal line BB. The seventh through ninth rows show that when the mode identification signal 3 is at the on state, the encoder module 21 sends out a control signal for making the selector module SL3 select the test path TP onto the signal line BA, and also sends out a control signal for making the selector module SL4 select the test path TP2 onto the signal line BB. The tenth through twelfth rows show that otherwise the encoder module 21 sends out a control signal for making the selector module SL3 select the test path TP onto the signal line BA, and also sends out a control signal for making the selector module SL4 select the test path TP3 onto the signal line BB.

In performing step ST5 (FIG. 2) of inserting a branch module, the description creating unit 12 selects a gate module that effectively transmits signals in a secondary mode (e.g., a test mode) among a plurality of circuit components (e.g., IPs) that are connected to one another in the secondary mode based on analytical results from the analyzer 11. The description creating unit 12 then creates and holds a description concerning the gate module. The designer has completed a table as shown in FIG. 8 in which the normal use mode and a plurality of secondary modes are described. In the connection condition analysis of step ST3, the description creating unit 12 creates a condition definition sentence that associates the mode at each column of the table with a mode identification number.

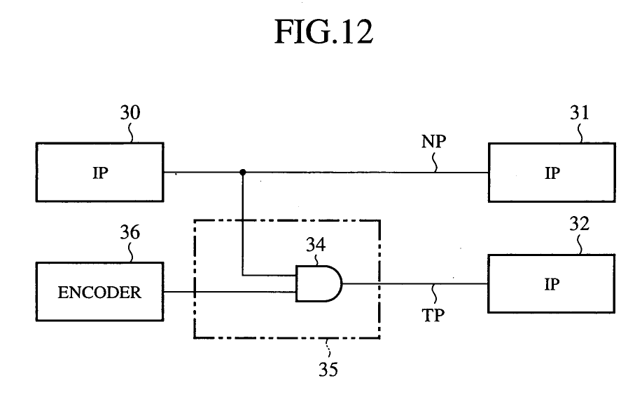

FIG. 12 is a circuit diagram concretely showing the branch module. According to the table completed by the designer, an output pin of an IP 30 is connected to an input pin of a circuit component module 31 in the normal use mode, and is connected to an input pin of a circuit component module 32 in a test mode. The circuit component modules 31 and 32 might be simply interconnecting lines substantially having no description.

The IP 30 only has to be connected to the circuit component module 31 used in the normal use mode by way of the path NP. However, in the normal use mode signals should be prevented from propagating from the IP 30 to the circuit component module 32 in most cases so that the power consumption is prevented from increasing. Then the description creating unit 12 creates a description concerning the gate module based on a connection recognition array so that the finally-acquired circuit has the structure as shown in FIG. 12. Although the description creating unit 12 creates and holds the connection recognition array according to the software program even for the insertion of this branch module, the connection recognition array created for the insertion of the branch module results from a search for destinations to which not an input pin but an output pin of each circuit component (e.g., an IP) is connected.

As shown in FIG. 12, an AND gate module 34 is disposed in the circuit finally acquired, and an output of the AND gate module 34 is connected to the circuit component module 32 to be used in the test mode by way of the test path TP. A branch line is branched on the way of the normal path NP, and is connected to an input of the AND gate module 34. The branch module 35 having the branch line, the AND gate module 34, and the test path TP is thus disposed.

Another input of the AND gate module 34 is connected to the encoder module 36 (i.e., the gate control module). The encoder module 36 provides a potential at a low level to the AND gate module 34 in the normal use mode of the LSI. Therefore, the potential on the test path TP is fixed to the low level in the normal use mode of the LSI, and the power consumption is reduced. On the other hand, in the test mode the encoder module 36 provides a potential at a high level to the AND gate module 34 so that a substantial connection from the IP 30 to the circuit component module 32 can be established. The encoder module 36 is defined based on the connection conditions acquired in the connection condition analysis step (i.e., step ST3 of FIG. 2).

In an actual description, the description creating unit 12 describes an instance call sentence of a fixed module in order to specify the AND gate module. For example, the description creating unit 12 describes an instance call sentence of a fixed module as follows.

TBKTO1 (.A(specification of name of output signal from output pin of IP),.B(specification of name of signal that changes to low level in normal use mode),.N(specification of normal path node),.T(specification of test path node));

where TBKTO1 is an alias of the gate module and the alias of the gate module is not limited to this example, and the designer can determine it arbitrarily.

If only one destination is connected to an output pin of an IP and the connection is established only in the normal use mode, the description creating unit 12 creates a definition sentence defining arrangement of only a buffer rather than an AND gate module in the branch module or creates a simple connection definition sentence. In contrast, when only one destination is connected to an output pin of an IP and the connection is established only in the test modes, although the normal path is not connected to the output pin and only the test path is connected to the output pin, an AND gate module is arranged on the way of the test path and an input of the AND gate module is connected to the encoder module. In this case, the encoder module provides a potential at a low level to the AND gate module normal in the use mode, and provides a potential at a high level to the AND gate module in the test modes. As a result, while in the test modes a substantial connection from the output pin of the IP to the output of the AND gate module can be established, the potential of the output of the AND gate module is fixed to the low level in the normal use mode and the power consumption is reduced.

When there are two or more test paths connected to one output pin of an IP, the output of the AND gate module only has to be connected to an input of another AND gate module so that each of these AND gate modules are controlled by the encoder module.

In performing step ST6 (FIG. 2) of inserting a special module, the description creating unit 12 selects a gate module arranged between a circuit component (e.g., an IP) in which the feeding of power can be stopped and another circuit component (e.g., an IP), for controlling transmission of signals between these circuit components, based on analytical results from the analyzer 11. The description creating unit 12 then creates and holds information about the gate module. When the analyzer 11 analyzes a file in which whether or not the feeding of power to each circuit component can be stopped is described in addition to the above-mentioned connection conditions and connections, the step of inserting a special module is carried out. Therefore, it is a prerequisite for the insertion of a special module that the designer, in step ST1, has completed the table in which whether or not the feeding of power to each circuit component can be stopped is described. In performing step ST2 of reading the table, the analyzer 11 holds information indicating whether or not the feeding of power to each circuit component can be stopped.

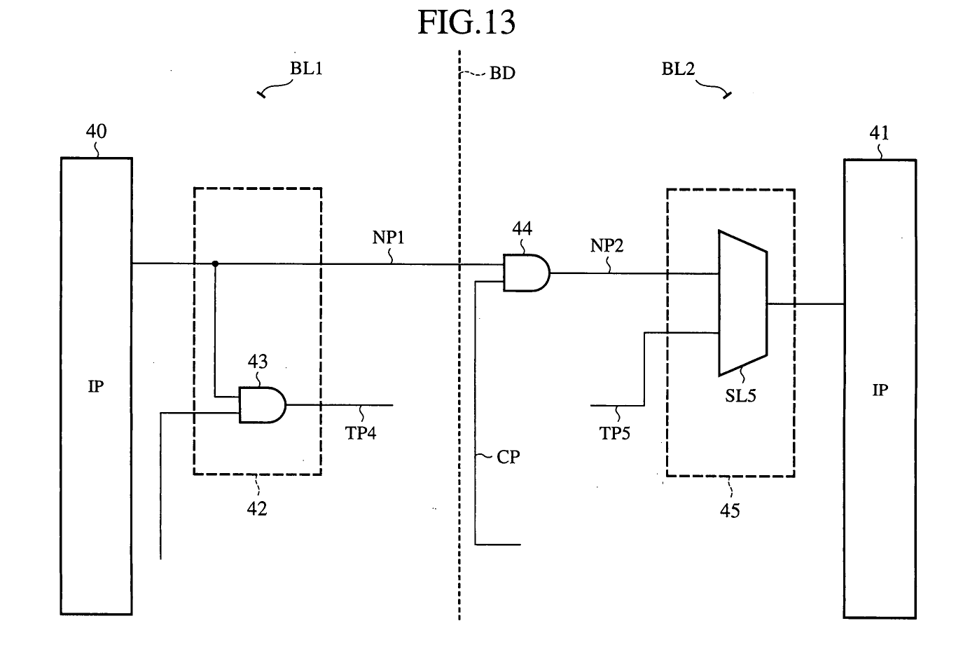

FIG. 13 is a circuit diagram concretely showing the gate module added through the insertion of a special module. As shown in the figure, in the same chip two blocks BL1 and BL2 exist with a boundary BD being placed between the two blocks. The block BL1 is a block in which the feeding of power to the block can be stopped while the LSI is working, and the block BL2 is a block to which power is always fed while the LSI is working. Signals from an IP 40 within the block BL1 needs to be furnished to an IP 41 within the block BL2 by way of a normal path NP1 in the normal use mode of the block BL1.

A branch module 42 is disposed in the block BL1 to prevent the power consumption from increasing in the test mode of the block BL1. In other words, a branch line is branched on the way of the normal path NP1 and is connected to an input of an AND gate module 43. Only when a potential at a high level is applied to another input of the AND gate module 43, the AND gate module 43 can furnish a test signal from the IP 40 to a test path TP4 connected to an output thereof.

On the other hand, a selector module SL5 for differentiating between the operation in the normal use mode of the block BL2 and signal flows in the test mode of the block BL2 is disposed within the block BL2. The selector module SL5 has two inputs respectively connected to a normal path NP2 and a test path TP5.

As shown in the figure, in the chip in which signals are furnished from the block BL1, in which the feeding of power to the block can be stopped while the LSI is working, to the block BL2, to which power is always fed (i.e., in which the feeding of power to the block cannot be stopped) while the LSI is working, even if the feeding of power to the block BL1 is stopped, the potential of a signal furnished from the IP 40 to the IP 41 doesn't actually become a low level for a while and therefore there is a possibility that a leakage current having a middle potential has a bad influence on the IP 41. To avoid this trouble, an AND gate module 44 (i.e., a special module) is placed between the IP 40 and the other IP 41 in the example shown in the figure.

The AND gate module 44 has an input connected to the normal path NP1 via which an output signal of the IP 40 flows, and another input connected to a control path CP. The AND gate module 44 has an output connected to the normal path NP2 via which signals input to the other IP 41 flow. Under such the structure, only when the potential of the control path CP has a high level, the normal path NP2 connected to the output of the AND gate module 44 can have a high potential. Therefore, by controlling the potential of the control path CP so that the potential has a low level at the same time when the feeding of power to the block BL1 is stopped, the potential of the normal path NP2 is always fixed to a low level and therefore no improper signal is furnished to the IP 41 after the feeding of power to the block BL1 is stopped.

In contrast, depending on the structure and operation mode of the target LSI, it may be desirable that the potential of the signal input to the IP 41 of the block BL2 be at a high level even after the feeding of power to the block BL1 is stopped. In this case, an OR gate module (not shown in the figure) can be disposed instead of the AND gate module 44. In this structure, by controlling the potential of the control path CP to be high at the same time when the feeding of power to the block BL1 is stopped, the potential of the normal path NP2 can be always fixed to a low level and therefore no improper signal is furnished to the IP 41 after the feeding of power to the block BL1 is stopped.

Thus a gate module arranged between the output of a circuit component in which the feeding of power to the circuit component can be stopped while the LSI is working and another circuit component, for controlling transmission of signals from the circuit component in which the feeding of power to the circuit component can be stopped (i.e., for fixing the potential of the output of the circuit component) is referred to as a special module (i.e., a neck tightening block), and a connection having this block is referred to as a specific connection.

When a signal at a high level delivered from a block, to which power is always fed (i.e., in which the feeding of power to the block cannot be stopped), is furnished to a drain or source of a p-channel MOS transistor within another block in which the feeding of power is stopped, there is a possibility that a leakage current is created between the source and drain of the p-channel MOS transistor because the direction of joint is a forward direction. To avoid this trouble, a gate module (e.g., a buffer) is placed between the block, to which power is always fed (i.e., in which the feeding of power to the block cannot be stopped), and the drain or source of the p-channel MOS transistor within the other block in which the feeding of power is stopped so that the drain current can be controlled accurately according to the gate voltage. The gate module arranged for such a purpose is also referred to a special module.

As shown in FIG. 13, when the branch module 42 exists within the block BL1 in which the feeding of power can be stopped while the LSI is working and the selector module SL5 exists within the other block BL2 to which power is always fed (i.e., in which the feeding of power cannot be stopped) while the LSI is working, such a special connection is located midway between the branch line of the branch module 42 and the selector module SL5.

As mentioned above, the designer, in step ST1, completes the table in which whether or not the feeding of power to each circuit component (e.g., an IP) can be stopped is described. In performing step ST2 of reading the table, the analyzer 11 holds information indicating whether or not the feeding of power to each circuit component can be stopped in an IP object representing the entire table. The analyzer 11 inserts a special module into an interconnection line crossing the boundary BD between the block to which power is always fed (i.e., in which the feeding of power cannot be stopped) and the block in which the feeding of power can be stopped based on this information. The analyzer 11 further stores a signal on the control path CP that becomes a low or high level when the feeding of power is stopped in the IP object, selects a gate module that obtains a logical product or logical OR of this signal and each signal in performing step ST6 of inserting a special connection, and creates and holds a description concerning this gate module.

Actually, in order to specify an AND gate module as the special module, the description creating unit 12 describes an instance call sentence of the following fixed module, for example.

AND NO1 (.A(specification of node of normal path NP1 within branch module),.B(specification of name of signal on control path CP),.Y(specification of node of normal path NP2 connected to input of selector module SL5));

where AND NO1 is an alias of the gate module, and the alias of the gate module is not limited to AND NO1 and the designer can determine it arbitrarily.

In order to specify an OR gate module as the special module, the description creating unit 12 describes an instance call sentence of the following fixed module.

OR NO2 (.A(specification of node of normal path NP1 within branch module),.B (specification of name of signal on control path CP),.Y (specification of node of normal path NP2 connected to input of selector module SL5));

where OR NO2 is an alias of the gate module, and the alias of the gate module is not limited to OR NO2 and the designer can determine it arbitrarily.

When blocks to each of which power is always fed (i.e., in which the feeding of power cannot be stopped) while the LSI is working are connected to each other, or when blocks in which the feeding of power is started and stopped at the same timing are connected to each other, such a special module is not needed. However, when a rule of disposing a special module to an interconnect line crossing a boundary BD between two blocks is provided, there is a need to go through the motions of providing a special module even though the special module is not essentially needed. In such a case, a buffer or interconnect line only has to be arranged in the special module nominally disposed. The description creating unit 12 creates a definition sentence defining an arrangement of only a buffer as the special module or creates a simple connection definition sentence.

In performing step ST7 (FIG. 2) of setting connections of each IP, the description creating unit 12 creates a description of connection conditions concerning a plurality of IPs within the LSI and connections of each IP according to each of these connection conditions with HDL based on analytical results of the analyzer 11. Therefore, in accordance with this embodiment, the automatic circuit design apparatus is able not only to describe connections between each pin (i.e., a pad or I/O cell) and each of the plurality of IPs within the LSI, but also to describe connections among the plurality of IPs in step ST7.

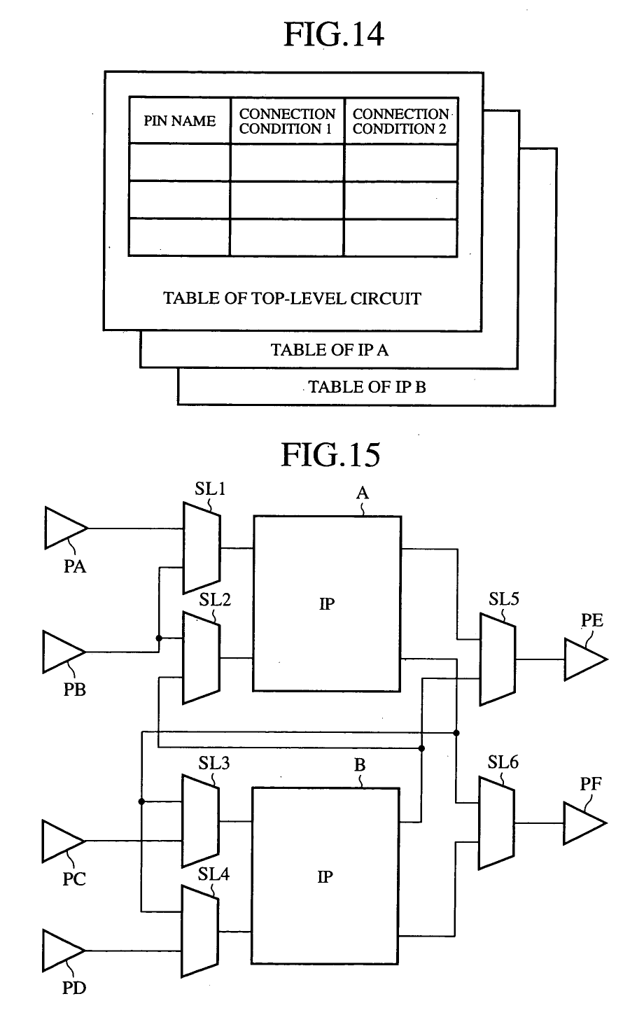

Therefore, as shown in FIG. 14, it is a prerequisite for the setting of connections of each IP that the designer, in step ST1, has completed the top-level table in which connection conditions concerning the plurality of circuit components (i.e., pins and IPs) within the entire LSI and connections of each circuit component corresponding to each of these connection conditions are described and the plurality of low-level tables in each of which connection conditions concerning internal elements within a corresponding one of the plurality of IPs and connections of each internal element corresponding to each of these connection conditions. In performing step ST2 of reading those tables, the analyzer 11 holds an IP object representing the top-level table (i.e., the entire LSI) and a plurality of IP objects each representing a corresponding low-level table (i.e., a corresponding one of the plurality of IPs) in addition to pin objects respectively corresponding to pins. In steps ST3 to ST6, the analyzer 11 adds or changes the description of a module or signal as a method used by an object, as mentioned above. The analyzer 11 then, in step ST7, creates and holds a description concerning connections of each IP.

When the designer prepares only one table, as shown in FIG. 3, the designer cannot describe connections among the plurality of IPs with HDL because he or she can only describe connections between IPs and pads in the table. Therefore the designer can prepare the plurality of low-level tables in each of which connection conditions concerning a plurality of internal elements within a corresponding IP and connections of each internal element corresponding to each of these connection conditions are described so as to describe connections among the plurality of IPs with HDL based on these tables. If the designer writes conditions under which connections among the internal elements within each IP are established according to a united rule when creating these tables, the automatic circuit design apparatus makes it possible to create a control signal creating module (i.e., an encoder module) for creating control signals for a number of selector modules to be created, in step ST4, by the automatic circuit design apparatus. In other words, the automatic circuit design can reduce the number of control signal creating modules to a minimum.

FIG. 15 is a circuit diagram showing an example of the top-level circuit that can be automatically designed based on a plurality of tables through the setting of connections of each IP. As shown in FIG. 15, while pins PA to PF are connected to IPs A and B by way of selector modules SL1 to SL6, an output pin of the IP B is connected to an input pin of the IP A by way of the selector module SL2 and an output pin of the IP A is connected to an input pin of the IP B by way of the selector modules SL3 and SL4. Thus the automatic circuit design apparatus can automatically design a considerably-complicated circuit in which there are connections among IPs. A control signal creating module can be so designed as to control all or either of the plurality of selector modules SL1 to SL6.

In performing the last step ST8 (FIG. 2) of outputting a circuit description written in HDL, the automatic circuit design apparatus outputs the descriptions held (or registered) in the above-mentioned steps of inserting selector modules, inserting branch modules, inserting special modules, and setting connections of each IP in accordance with a grammar of the circuit language description. Concretely, the automatic circuit design apparatus defines each module to be used within the entire LSI to be designed, and describes an instance definition indicating connections of each IP and connections of each pin (i.e., a pad or I/O cell) in each module definition. The automatic circuit design apparatus further provides instance definitions of the registered branch modules, selector modules, and special modules in the module definition of the entire target LSI. After that, the automatic circuit design apparatus closes the module definition of the entire target LSI and adds the module definition of each selector module to the module definition of the entire target LSI. In addition, the automatic circuit design apparatus adds the module definition of a control signal creating module (i.e., an encoder module) to the module definition of the entire target LSI. The automatic circuit design apparatus thus creates and outputs the description written in HDL (or RTL) and associated with the entire LSI to be designed so as to create an RTL file.

The software program can be so created that the automatic circuit design apparatus automatically creates composite scripts to be applied to a logical synthesis tool by using tables, and carries out a logical synthesis by using these composite scripts. The automatic circuit design apparatus can logically synthesize a circuit description written in RTL and concerning the entire LSI, which is created in step ST8. As a result, the automatic circuit design apparatus automatically creates the logic circuit of a netlist. A composite script is a simple program in which design limiting conditions or rules for logically synthesizing a circuit description written in RTL into a netlist are written in a script language.

The processor 1 can extract the synthetic conditions or rules for logically synthesizing a circuit description from the tables, and can create a composite script by using these synthetic conditions or rules. The automatic circuit design apparatus can carry out a logical synthesis only by allowing the logical synthesis tool to this composite script. Because there are different connections among circuit components according to connection conditions, as mentioned above, there is a need to create a plurality of logic circuits and a plurality of composite scripts are therefore needed. When there are many instance sentences to be specified in RTL, it takes much time to create a lot of composite scripts while the composite efficiency can be improved by automatically creating the plurality of composite scripts.

In addition, the automatic circuit design apparatus can create test patterns to verify connections among the plurality of circuit components within the LSI by using the tables and can be so implemented via software as to verify connections among the plurality of circuit components by using those test patterns. When forcedly and virtually applying each test pattern to an output node of each IP, the automatic circuit design apparatus can recognize a connection between each IP and another IP if the same test pattern is read from an input node of the destination to which the output node of each IP is connected.

The processor 1 can automatically create test patterns from the tables in order to check to see connections among the plurality of circuit components within the LSI. Although the test patterns are simple, it takes considerable time to create the test patterns because each test pattern has a large amount of description. However, it is possible to improve the verification efficiency by automatically creating the test patterns. The verification can be performed on the circuit description written in HDL. As an alternative, the verification can be performed on the synthesized netlist.

As mentioned above, in accordance with this embodiment 1, the automatic circuit design apparatus that operates according to a software program includes the analyzer 11 for analyzing a table in which both connection conditions concerning a plurality of circuit components within an LSI and connections among the plurality of circuit components corresponding to each of the connection conditions are described, and the description creating unit 12 for creating a description of the LSI written in HDL based on analytical results from the analyzer 11. As a result, the present embodiment offers an advantage of being able to facilitate the design automation of the integrated circuit in which the plurality of circuit components are connected to one another, thereby proving savings in time and in manpower when creating the circuit description with HDL. The designer can create the table without needing knowledge about the grammar of HDL and the know-how about placement of circuit components and only has to write only conditions under which connections are established and connections corresponding to each of the conditions into the table. In other words, the designer only has to fill in the blanks of the table according to a simple format. Furthermore, because the format of the table is extremely simple, it is easier to learn than HDL and even a designer who doesn't have a special technology can create the table.

Because the circuit design based on such a table is effective for a circuit in which a plurality of modules are connected to one another, the circuit design is useful for not only a top-level circuit but also a relatively-high-level circuit.

Particularly, in accordance with this embodiment 1, because the description creating unit 12 selects one or more selector modules suitable for implementing connections among the plurality of circuit components corresponding to each of the connection conditions based on analytical results from the analyzer 11, and adds information about the one or more selector modules to the description of the LSI, the designer need not select the one or more selector modules according to each of the connection conditions and even a designer who doesn't have a special technology can design the circuit with HDL.

Furthermore, in accordance with this embodiment 1, because the description creating unit 12 adds information about a control signal creating module suitable for creating a control signal used to control the selector module to the description of the LSI based on the analytical results from the analyzer 11, the designer need not select the control signal creating module (i.e., an encoder module) according to each of the connection conditions and even a designer who doesn't have a special technology can design the circuit with HDL.

In addition, in accordance with this embodiment 1, the analyzer 11 analyzes the table in which a normal use mode in which the LSI is normally used and a plurality of secondary modes in which the LSI is secondarily used are described as the connection conditions, respectively, the description creating unit 12 selects a first selector module SL3 disposed among the plurality of circuit components that are connected to one another in the normal use mode based on the analytical results from the analyzer 11, selects a second selector module SL4 suitable for implementing connections among the plurality of circuit components in each of the plurality of secondary modes, and adds information about the first and second selector modules SL3 and SL4 to the description of the LSI so that an output of the second selector module SL4 is connected to an input of the first selector module SL3. Therefore, even if one normal path NP and a plurality of test paths TP are disposed in the designed LSI, because the first selector module SL3 has only two choices: the normal path NP and the test path group, the first selector module SL3 has the simplest internal structure (e.g., the number of internal gates and wiring pattern) among the plurality of selectors. Therefore, in the normal use mode, high-speed processing can be implemented and low power consumption can be achieved.

Furthermore, in accordance with this embodiment 1, the analyzer 11 analyzes the table in which a normal use mode in which the LSI is normally used and a secondary mode in which the LSI is secondarily used are described as the connection conditions, respectively, and the description creating unit 12 selects a gate module 34 that effectively transmits a signal in the secondary mode among the plurality of circuit components that are connected in the secondary mode based on the analytical results from the analyzer 11 and adds information about the gate module 34 to the description of the LSI. Therefore, the potential at an output of the gate module 34 is fixed to a low level in the normal use mode and the power consumption is reduced.

In addition, in accordance with this embodiment 1, the analyzer 11 analyzes the data set in which information about whether or not feeding of power to each of the plurality of circuit components can be stopped is described in addition to the connection conditions and connections, and the description creating unit 12 selects a gate module 44 arranged between a circuit component in which feeding of power can be stopped and another circuit component, for controlling transmission of signals between those circuit components, based on the analytical results from the analyzer 11, and adds information about the gate module 44 to the description of the target LSI. Therefore, after stopping the feeding of power to the circuit component in which the feeding of power thereto can be stopped, the automatic circuit design apparatus can fix the potential of the output of the gate module 44 to a low level or a high level, thus preventing improper signals from being furnished to the other circuit component.

Furthermore, in accordance with this embodiment 1, the analyzer 11 analyzes both a higher-level data set in the form of a table, in which both connection conditions concerning the plurality of circuit components within the LSI and connections among the circuit components corresponding to each of the connection conditions are described, and a plurality of lower-level data sets in the form of a table, in each of which both connection conditions concerning internal elements within a corresponding one of the plurality of circuit components and connections among the internal elements corresponding to each of the connection conditions are described, and the description creating unit 12 creates an overall description of the entire LSI and the plurality of circuit components at a time based on the analytical results from the analyzer 11. Therefore, the automatic circuit design apparatus can automatically design a considerably-complicated circuit in which there are connections among IPs with HDL based on those tables.

Next, a description will be made as to an example of the description of an LSI which is created by the automatic circuit design apparatus according to above-mentioned embodiment 1.

The automatic circuit design apparatus creates a description of the LSI written in HDL based on a top-level table in which connections within an entire LSI are described and a plurality of low-level tables in each of which connections within each IP are described, those tables being created by a designer.

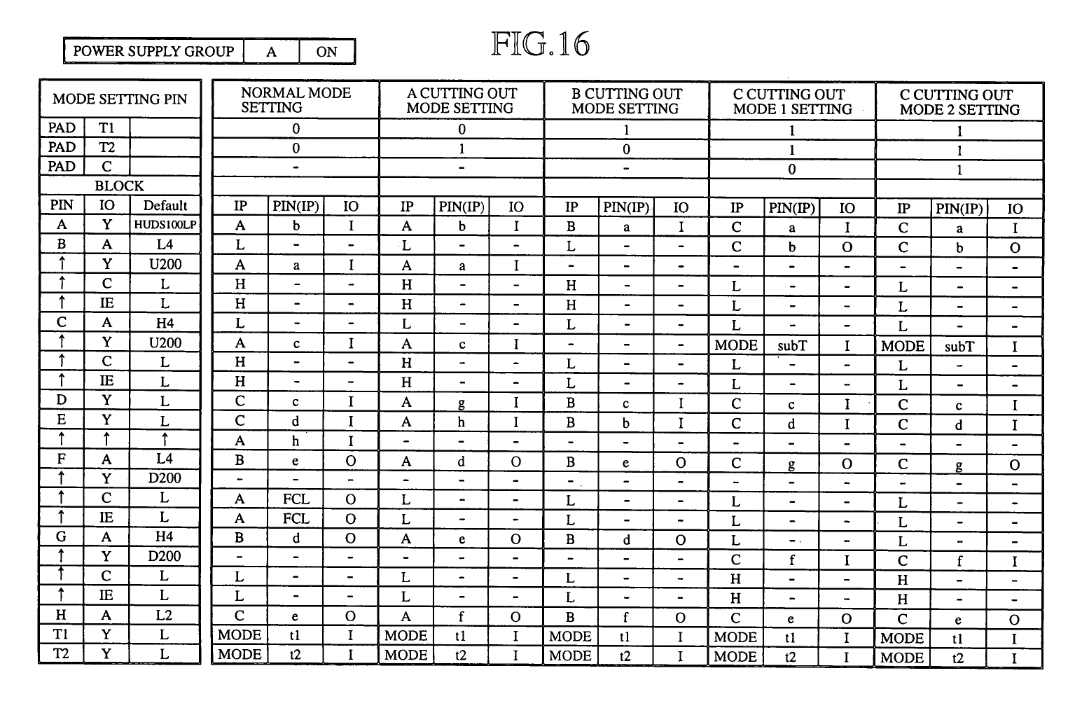

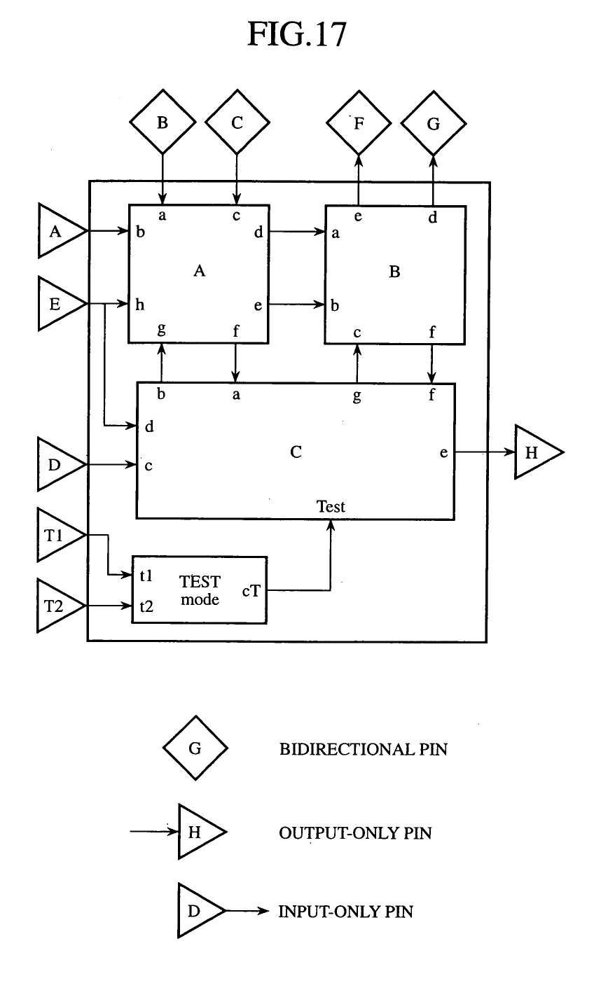

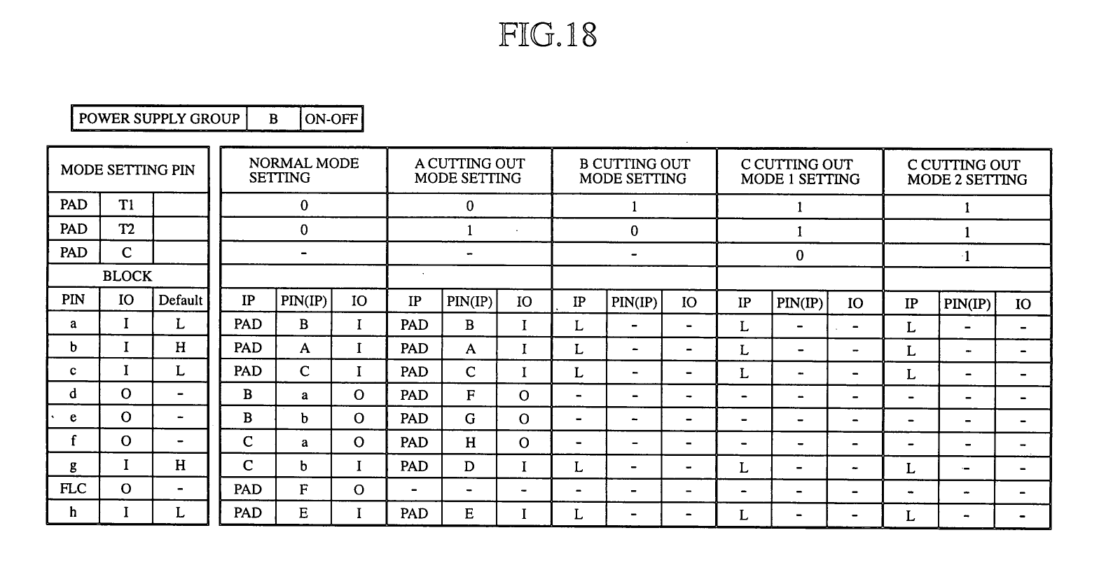

FIG. 16 shows a top-level table, FIG. 17 is a circuit diagram showing a designed top-level circuit placed in a normal use mode, and FIGS. 18 to 20 show a plurality of low-level tables for IPs A to C within the top-level circuit, respectively. As shown in FIG. 17, the top-level circuit has the three IPs A to C each enclosed by a rectangular box.

The names of pins A to H, T1 and T2 of I/O buffers, which are terminals of the LSI, are filled in the leftmost column of FIG. 16 showing connections of the top-level circuit. The leftmost column shows that the pins A, E, D, T1 and T2 are output pins of input buffers and their output signal name is Y, the pin H is an input pin of an output buffer and its input signal name is A, and the remaining pins B, C, F and G are bidirectional pins, and their input or output signal names are A, Y, C and IE.

There are five operation modes (i.e., connection conditions) for the LSI. In other words, there are a normal mode (i.e., a normal use mode), a cutting out mode (i.e., A cutting out mode) for the IP A (i.e., a test mode in which the IP A is individually tested), a cutting out mode (i.e., B cutting out mode) for the IPB, and two cutting out modes (i.e., C cutting out modes 1 and 2) for the IP C. Under the name of each mode in the table a condition under which each mode can be established is filled in. Either one of the above-mentioned five modes is set according to signals that appear at the pins T1, T2 and C. For example, when signals that appear at the pins T1 and T2 are at state 0, the LSI is placed in the normal use mode. When signals that appear at all of the pins T1, T2, and C are at state 1, the LSI is placed in the C cutting out mode 2.

FIG. 16 shows with which pin, as an input pin or output pin of which IP, is connected to each of the pins A to H, T1 and T2 in each mode. Each IP subdivided column in the table identifies which IP is connected to a corresponding pin, each PIN (IP) subdivided column identifies which pin within the IP specified by each IP subdivided column is connected to the corresponding pin, and each IO subdivided column identifies whether the pin is an input pin (I) or output pin (O). For example, as shown in FIG. 16, in the normal use mode the pin A is connected to the pin b as an input pin of the IP A, and the pin B is connected to the pin a as another input pin of the IP A.

FIGS. 18 to 20 show pin names within the IPs A to C and connection destinations to which pins are connected in each mode, respectively, and also show each mode and a condition under which each mode can be established, like FIG. 16. Items to be written into each mode column are uniformly defined for all the tables.

The names of pins within the IPs A to C are filled in the leftmost subdivided columns of the tables of FIGS. 18 to FIG. 20, respectively, and whether each pin is an input pin (I) or output pin (O) is filled in the next subdivided column. FIGS. 18 to 20 also show with which pin, as an input pin or output pin of which IP (or pad), is connected to each pin in each mode. Each IP subdivided column in each table identifies which IP is connected to a corresponding pin, each PIN(IP) subdivided column identifies which pin within the IP or pad specified by each IP subdivided column is connected to the corresponding pin, and each IO subdivided column identifies whether the pin is an input pin (I) or an output pin (O).

The information indicating the connections is filled in those tables so that there is a contradiction among the connections specified by the tables of FIGS. 18 to 20. For example, while FIG. 16 shows that the pin A is connected to the pin b as an input pin of the IP A in the normal use mode, FIG. 18 shows that the pin b of the IP A is connected to the pin A of a pad as an input pin in the normal use mode.

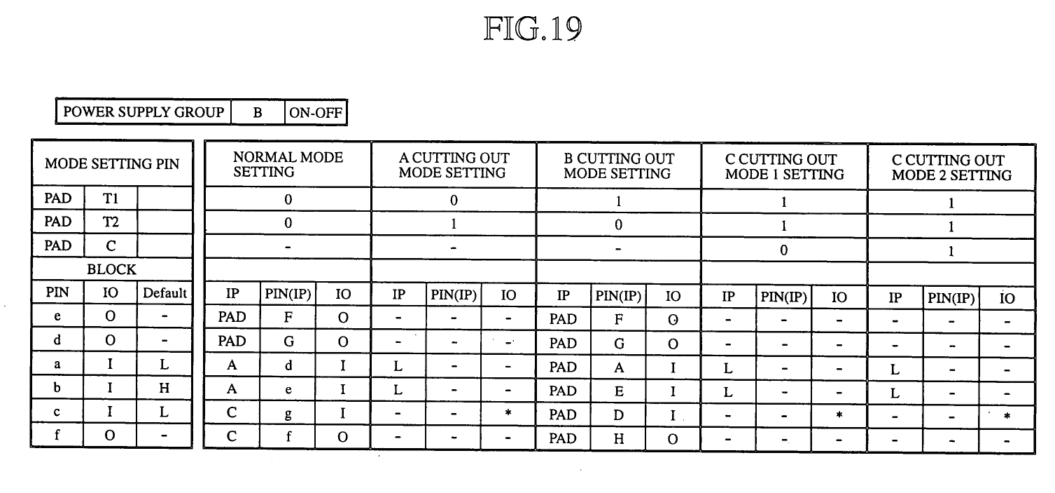

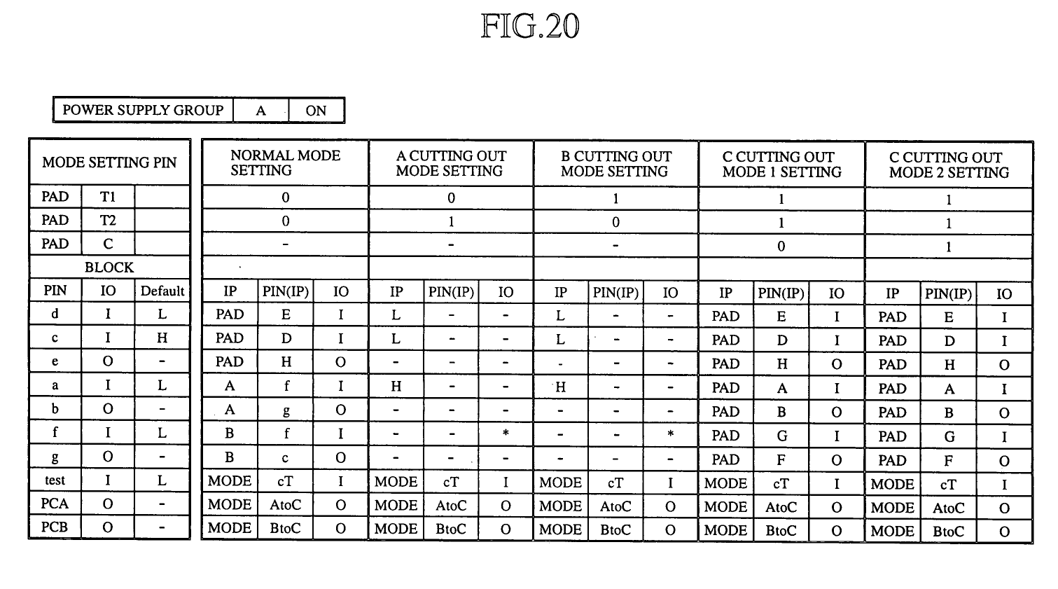

Furthermore, the type and characteristic of a power supply to which the top-level circuit or an IP is connected are shown in each table. The power supply to which the top-level circuit and the IP C are connected is A, as shown in FIGS. 16 and 20, and is always turned on while the LSI is working. The power supply to which the IPs A and B are connected is B, as shown in FIGS. 18 and 19, and can be turned on and off while the LSI is working. Therefore, while power is always fed to the IP C when the LSI is working, the feeding of power to the IPs A and B can be stopped when the LSI is working.

These tables can be read by the program (in steps ST2 and ST7 of FIG. 2). The connection information about each row in each table is stored in a pin object for storing a connection destination to which each pin is connected, and is also stored in an IP object including data on the pin object. In the pin object, a signal line that connects a pin in the leftmost subdivided column of each table with a corresponding connection destination is specified and registered. Furthermore, information indicating whether or not the feeding of power to each IP can be stopped is held in the IP object representing each entire table.

The condition (i.e., the connection condition) under which each mode can be established is evaluated first (in step ST3 of FIG. 2). In the case of the LSI of FIG. 17, in which mode the LSI is to be placed is determined by a combination of signals that appear at three pad pins T1, T2, and C. Based on the condition described in the table of FIG. 16 (i.e., the connection condition) under which each mode can be established, the five modes can be described as follows.

function MODESE begin

input [2:0] in;
output [4:0] mode;
casex (in) begin

3′b00x: mode = 5′b00001;
3′b01x: mode = 5′b00010;
3′b10x: mode = 5′b00100;
3′b110: mode = 5′b01000;
3′b111: mode = 5′b10000;

end

end

assign {LSI_MODE_04, LSI_MODE_03, LSI_MODE_02, LSI_MODE_01, LSI_MODE_00}=M0DESE({PAD_T1_X, PAD_T2_Y, PAD_C_Y});

As a result, operation modes LSI_MODE_00 to LSI_MODE_04 are determined by a combination [00x, 01x, 10x, 110, 111] of a signal PAD_T1_X from a pad pin T1, a signal PAD_T2_Y from a pad pin T2, and a signal PAD_C_Y from a pad pin C (see each table). The operation mode LSI_MODE_00 is the normal mode, and the operation mode LSI_MODE_04 is the C cutting out mode 2.

After that, the processor 1 checks a connection destination to which each output pin is connected so as to create a connection recognition array, and creates a branch module based on this connection recognition array (in step ST5 of FIG. 2). The processor 1 also checks a connection destination to which each input pin is connected so as to create a connection recognition array, and creates a selector module based on this connection recognition array (in step ST4 of FIG. 2).

For example, because the pin A of FIG. 16 is an output pin of an input buffer, an output signal Y is input to each IP. While even in the normal mode and in the A cutting out test mode, the pin A is connected to the pin b of the IP A, the pin A is connected to the pin a of the IP B in the B cutting out mode and is connected to the pin a of the IP C in the C cutting out mode. A connection recognition array (1, 1, 2, 3, 3) indicating the connection destinations of the pin A is thus formed and the number of connections of the pin A is therefore 3. 1, 2 and 3 within the connection recognition array show the pin b of the IP A, the pin a of the IP B, and the pin a of the IP C, respectively. Branch modules are formed because the number of connections is 3, and an output node of each branch module is defined. For example, the node name of a normal path from the pin A to the IP A is defined as PAD_A_N, and the node name of a test path from the pin A to the IPs B and C is defined as PAD_A_M. An output signal Y from the pin A is defined as PAD_A_Y and stocked.

This information is delivered as the following instance call sentence when the circuit description written in HDL is output (in step ST8 of FIG. 2).

TKM TO1(.A(PAD_A_Y).,B(LSI_MODE_00_0 B),.N(PAD_A_N),,T(PAD_A_M));

where TKM TO1 is an alias of a gate module, and the alias of the gate module is not limited to TKM TO1 and the designer can determine it arbitrarily. Array elements in the subsequent parentheses are (.A(specification of a name of an output signal from an output pin of IP),.B(specification of a name of a signal that becomes a low level in the normal mode),.N(specification of a normal path node),.T(specification of a test path node)). For example, LSI_MODE_00_B is a signal that becomes a low level in the normal mode and becomes a high level otherwise, and is created and defined when the encoder module (i.e., the gate control module) is inserted.

On the other hand, when a pin, such as a pin PCA of the IP C described in FIG. 20, has the same connection destinations for all conditions even though it is an output pin (e.g., when it is connected to a pin AtoC of a MODE module), the number of connections is 1 and the connection recognition array is (1, 1, 1, 1, 1). In this case no branch module is created and a description indicating the connection or a sentence indicating only a simple buffer is inserted in a place where a branch module should have been inserted. The simple buffer is described as follows.

TKB T13(.A(C_PCA_O),.Y(C_PCA_N));

where TKB T13 is an the buffer module, and the alias of the buffer module is not limited to TKB T13 and the designer can determine it arbitrarily. Array elements in the subsequent parentheses (.A(specification of a signal line input to the buffer),.Y (specification of a signal line output from the buffer)). In other words, the signal line toward the MODE module is defined and stored as C_PCA_N.

For an input pin, a selector module is inserted when the input pin has a plurality of connection destinations connected thereto (in step ST4 of FIG. 2). Even in this case, a connection recognition array is first created, and a selector module is created according to the connection recognition array.

For example, because the pin H of FIG. 16 is an input pin of an output buffer, a selector module is created. The pin H is connected to a pin e of the IP C in the normal mode, is connected to a pin f of the IP A in the A cutting out mode, is connected to a pin f of the IP B in the B cutting out mode, and is connected to the pin e of the IP C in the C cutting out mode as in the case of the normal mode. In this case, the connection recognition array is (1, 2, 3, 1, 1). 1, 2 and 3 within the connection recognition array represents the pin e of the IP C, the pin f of the IP A, and the pin f of the IP B, respectively. Because the number of connections is 3, a first selector module that differentiates between a normal path and test paths and a second selector module that differentiates between the test paths are created. Assuming that an input terminal with which the normal path of the first selector module is connected to be N, a signal line named C_e_N that must have been created as a normal path when a branch module that is a connection destination was created is registered so that the signal line is connected to the input terminal N as the normal path, and a signal line named A_f_M that is a connection destination in the A cutting out mode is registered so that the signal line is connected to an input terminal with which one test path of the second selector module is connected as a test path. When the branch module is created, the signal line A_f_M must be defined as a connection destination of the pin f of the IP A of FIG. 18 that is a table concerning the IP A. In addition, a signal line named B_f_M that is a connection destination in the B cutting out mode is registered so that the signal line is connected to an input terminal with which the other test path of the second selector module is connected as a test path. When the branch module is created, the signal line B_f_M must be defined as a connection destination of the pin f of the IP B of FIG. 19 that is a table concerning the IP B.

In addition, in order to control the selector modules, the encoder module is so set as to deliver a selector module control signal to each selector module according to a signal indicating that an above-mentioned corresponding mode condition (i.e., a corresponding connection condition) is satisfied. For example, the encoder module is set to deliver a selector module control signal to each of the selector modules SL3 and SL4 based on the connection recognition array (e.g., (1, 2, 3, 1, 1)) in such a manner that when the connection destination in the normal mode is 1, the control signal A on the signal line BA of FIG. 9 makes the first selector module SL3 select the normal path NP and the control signal B on the signal line BB of FIG. 9 makes the second selector module SL4 select either one of the test paths TP1 to TP3, when the connection destination in the normal mode is 2, the control signal A on the signal line BA makes the first selector module SL3 select the test path TP and the control signal B on the signal line BB makes the second selector module SL4 select the test path TP1, and when the connection destination in the normal mode is 3, the control signal A on the signal line BA makes the first selector module SL3 select the test path TP and the control signal B on the signal line BB makes the second selector module SL4 select the test path TP2. When this encoder module is described in HDL, it is defined by conditional branch expressions within an if sentence in which signals each indicating that a corresponding mode condition is satisfied are defined as conditions, as follows, for example.

if (P0==1′b1) begin

A=1′b0; // Selector module control signal pattern when connection destination is 1

B=1′b0; end

else if (P1==1′b1) begin

A=1′b1; // Selector module control signal pattern when connection destination is 2

B=1′b0; end

else if (P2==1′b1) begin

A=1′b1; // Selector module control signal pattern when connection destination is 3

B=1′b1; end

else if (P3==1′b1) begin

A=1′b0; // Selector module control signal pattern when connection destination is 1

B=1′b0; end

else if (P4==1′b1) begin

A=1′b0; // Selector module control signal pattern when connection destination is 1

B=1′b0; end

where // is a comment start symbol and lines starting from the comment start symbol to their ends are comments. P4 to P0 are the module internal signal names of pins to which mode condition satisfaction signals (LSI_MODE_04 from LSI_MODE_00) are input. According to the conditional branch expressions, the plurality of test paths are not selected at the same time even though any one of the different mode condition signals is applied to the encoder module.

Furthermore, the two selector modules (i.e., the first and second selector modules) are defined as the following instance call sentences for modules, for example.

TSEL2TO1(.A(C_e_N),.B(SST),.S(A),.Y(PAD_H_A)); // Normal path and test path TSEL2GO1(.A(A_f_M),.B(B_f_M),.S(B),.Y(SST)); // Test path 1 and test path 2

where TSEL2 is the module name of the combination of the two selector modules, and TO1 represents the first selector module and GO1 represents the second selector modules. A and B in parentheses represent input signals to each selector module, S represents a selector module control signal, and Y represents an output signal of each selector module. SST represents a signal that is delivered from the second selector module G01 to the first selector module T01.

A selector module is needed for an input pin having a plurality of connection destinations connected thereto. No selector module is not inserted into an input pin with a connection recognition array that consists of only 1s (i.e., the number of connections is 1). In this case, either a module having a definition only indicating connections or a module consisting of only a buffer is inserted a place where a selector module should have been inserted. For example, when a pin, such as a pin test as shown in FIG. 20, has the same connection destinations for all conditions even though it is an input pin (e.g., when it is connected to a pin cT of a MODE module), the number of connections is 1 and the connection recognition array is (1, 1, 1, 1, 1). In this case no selector module is created and a description indicating the connection or a sentence indicating only a simple buffer is inserted in a place where a selector module should have been inserted. For instance, the description representing the connection is provided as follows.

CONNE01 T02(.A(MODE_cT_N),.Y(C_test_I));

where CONNE01 is a module representing only the connection, and A and Y in the parentheses show pins that are connected to each other.

An internal circuit of each selector module is uniquely determined according to the number of connection destinations. Therefore, there exists a number of types of selector modules to be used in the LSI to be designed, which is equal to the number of different numbers of connection destinations that can be established in the LSI. When each selector module is registered, the number of connection destinations is examined. If the examined number is a new number (i.e., if it doesn't agree with any of the different numbers of connection destinations for selector modules which have already been used), a definition of the new type of selector module is described and registered. When a definition of selector module having the same number of connection destinations as that of a newly-created selector module has already been registered, the processor eliminates duplicated definitions without definition of the type of the newly created selector module and creates and registers only an instance call sentence.

The structure of an entire module that consists of a combination of a plurality of selector modules differs according to the type of the connection recognition array. A plurality of input pins having the same connection recognition array, such as a plurality of input pins of a certain IP, can exist. Connection recognition arrays can be registered. In this case, when a module having the same connection recognition array as a newly-created module has already been registered, only an instance call sentence is defined without definition of the newly created module in order to eliminate duplicated definitions. In the case of anew connection recognition array, a definition of the newly created module is described and registered.

As previously mentioned, the type and characteristic of a power supply to which the top-level circuit or an IP is connected are shown in each table. When a block to which power is always fed while the LSI is working and another block in which the feeding of power thereto can be stopped are connected to each other, a special module is inserted into the LSI (in step ST6 of Fig. 2). This insertion is needed to prevent the possibility that the gate of the block to which power is always fed causes a leakage current of midpoint potential to flow when the power supply is turned off in the other block in which the feeding of power thereto can be stopped and the output of the other block has a midpoint potential. Therefore, an AND gate module is inserted between those blocks. When the feeding of power to the block in which the feeding of power thereto can be stopped is stopped, an signal at a low level is input to one input of the AND gate module and the output potential of the block is fixed to the low level.

As shown in FIGS. 16 and 20, the power supplies of the top-level circuit and the IP C are A, and the power supply A is always turned on while the LSI is working. As shown in FIGS. 18 and 19, the power supplies of the IPs A and B are B, and the power supply B can be turned on and off while the LSI is working. Therefore, a special module is inserted between the output pin of the IP A and another IP or a pad, and a special module is also inserted between the output pin of the IP B and another IP or a pad. No special module is inserted into the output pins of other IPs or input pads, and a description showing only a connection or a sentence showing only a simple buffer is alternatively inserted. A gate module as a special module is described by an instance call sentence as previously mentioned.

When outputting the circuit description written in HDL in the last step ST8 (see FIG. 2), the automatic circuit design apparatus outputs the descriptions held (or registered) in the already-processed steps in accordance with the grammar of RTL. In addition, the automatic circuit design apparatus automatically creates composite scripts to be applied to a logical synthesis tool by using the tables, and carries out a logical synthesis by using these composite scripts. Furthermore, the automatic circuit design apparatus creates a test pattern to verify connections among the plurality of circuit components included in the target LSI for a composite netlist and carries out automatic verification, as previously mentioned.

The RTL description representing the created top-level circuit is shown as follows.

Many widely different embodiments of the present invention may be constructed without departing from the spirit and scope of the present invention. It should be understood that the present invention is not limited to the specific embodiments described in the specification, except as defined in the appended claims.

What is claimed is:

1. An automatic circuit design apparatus comprising:
an analyzer for analyzing a data set in a form of a table, both connection conditions concerning a plurality of circuit components within an integrated circuit and connections among the circuit components in each of the connection conditions being described in the data set; and
a description creating unit for creating a description of the integrated circuit with a hardware description language based on analytical results from said analyzer.

2. The automatic circuit design apparatus according to claim 1, wherein said description creating unit selects one or more selector modules suitable for implementing connections among the plurality of circuit components in each of the connection conditions based on the analytical results from said analyzer, and adds information about said one or more selector modules to the description of the integrated circuit.

3. The automatic circuit design apparatus according to claim 2, wherein said description creating unit adds information about a control signal creating module suitable for creating a control signal used to control said one or more selector modules to the description of the integrated circuit based on the analytical results from said analyzer.

4. The automatic circuit design apparatus according to claim 2, wherein said analyzer analyzes the data set in which the connection conditions including a normal use mode in which the integrated circuit normally operates and a plurality of secondary modes in which the integrated circuit secondarily operates are described, and said description creating unit selects a first selector module disposed among the circuit components that are connected to one another in the normal use mode based on the analytical results from said analyzer, selects a second selector module suitable for implementing connections among the circuit components in each of the plurality of secondary modes, and adds information about said first and second selector modules to the description of the integrated circuit so that an output of said second selector module is connected to an input of said first selector module.

5. The automatic circuit design apparatus according to claim 1, wherein said analyzer analyzes the data set in which the connection conditions including a normal use mode in which the integrated circuit normally.Qperates and a secondary mode in which the integrated circuit secondarily operates are described, and said description creating unit selects a gate module that effectively transmits a signal in the secondary mode among the circuit components that are connected to one another in the secondary mode based on the analytical results from said analyzer and adds information about said gate module to the description of the integrated circuit.

6. The automatic circuit design apparatus according to claim 5, wherein said selected gate module has an output that is disabled in response to a control signal in the normal use mode.

7. The automatic circuit design apparatus according to claim 1, wherein said analyzer analyzes the data set in which information about whether or not feeding of power to each of the plurality of circuit components can be stopped is described in addition to the connection conditions and connections, and said description creating unit selects a gate module arranged between a circuit component in which feeding of power can be stopped and another circuit. component, for controlling transmission of signals between those circuit components, based on the analytical results from said analyzer, and adds information about said gate module to the description of the integrated circuit.

8. The automatic circuit design apparatus according to claim 7, wherein said selected gate module has an output that is disabled in response to a control signal when feeding of power is stopped.

9. The automatic circuit design apparatus according to claim 1, wherein said analyzer analyzes both a higher-level data set in a form of a table, in which both connection conditions concerning the plurality of circuit components within the integrated circuit and connections among the circuit components corresponding to each of the connection conditions are described, and a plurality of lower-level data sets in a form of a table, in each of which both connection conditions concerning internal elements within a corresponding one of the plurality of circuit components and connections among the internal elements corresponding to each of the connection conditions are described, and said description creating unit creates an overall description of the entire integrated circuit and said plurality of circuit components at a time based on the analytical results from said analyzer.

10. A computer-implemented automatic circuit design method comprising the steps of:
analyzing a data set in a form of a table, both connection conditions concerning a plurality of circuit components within an integrated circuit and connections among the circuit components in each of the connection conditions being described in the data set; and
creating a description of the integrated circuit with a hardware description language based on analytical results obtained in the step of analyzing the data set.

11. The computer-implemented automatic circuit design method according to claim 10, wherein the step of creating includes the steps of selecting one or more selector modules suitable for implementing connections among the plurality of circuit components in each of the connection conditions based on the analytical results, and adding information about said one or more selector modules to the description of the integrated circuit.

12. The computer-implemented automatic circuit design method according to claim 11, wherein the step of creating includes the step of adding information about a control signal creating module suitable for creating a control signal used to control said one or more selector modules to the description of the integrated circuit based on the analytical results.

13. The computer-implemented automatic circuit design method according to claim 11, wherein the step of analyzing is the step of analyzing the data set in which the connection conditions including a normal use mode in which the integrated circuit normally operates and a plurality of secondary modes in which the integrated circuit secondarily operates are described, and the step of creating includes the steps of selecting a first selector module disposed among the circuit components that are connected to one another in the normal use mode based on the analytical results, selecting a second selector module suitable for implementing connections among the circuit components in each of the plurality of secondary modes, and adding information about said first and second selector modules to the description of the integrated circuit so that an output of said second selector module is connected to an input of said first selector module.

14. The computer-implemented automatic circuit design method according to claim 10, wherein the step of analyzing is the step of analyzing the data set in which the connection conditions including a normal use mode in which the integrated circuit normally operates and a secondary mode in which the integrated circuit secondarily operates are described, and the step of creating includes the steps of selecting a gate module that effectively transmits a signal in the secondary mode among the circuit components that are connected to one another in the secondary mode based on the analytical results, and adding information about said gate module to the description of the integrated circuit.

15. The computer-implemented automatic circuit design method according to claim 14, wherein said selected gate module has an output that is disabled in response to a control signal in the normal use mode.

16. The computer-implemented automatic circuit design method according to claim 10, wherein the step of analyzing is the step of analyzing the data set in which information about whether or not feeding of power to each of the plurality of circuit components can be stopped is described in addition to the connection conditions and connections, and the step of creating includes the steps of selecting a gate module arranged between a circuit component in which feeding of power can be stopped and another circuit component, for controlling transmission of signals between those circuit components, based on the analytical results, and adding information about said gate module to the description of the integrated circuit.

17. The computer-implemented automatic circuit design method according to claim 16, wherein said selected gate module has an output that is disabled in response to a control signal when feeding of power is stopped.

18. The computer-implemented automatic circuit design method according to claim 10, wherein the step of analyzing is the step of analyzing both a higher-level data set in a form of a table, in which both connection conditions concerning the plurality of circuit components within the integrated circuit and connections among the circuit components corresponding to each of the connection conditions are described, and a plurality of lower-level data sets in a form of a table, in each of which both connection conditions concerning internal elements within a corresponding one of the plurality of circuit components and connections among the internal elements corresponding to each of the connection conditions are described, and the step of creating is the step of creating an overall description of the entire integrated circuit and said plurality of circuit components at a time based on the analytical results.
